(19) United States
(12) Patent Application Publication
(10) Pub. No.: US 2013/0165531 A1
(43) Pub. Date: Jun. 27, 2013

(54) Anthocyanin based colorant compositions

(71) Applicants: Jingang Shi, Beijing (CN); Hui Ma, Beijing (CN); Zhijin Jin, Beijing (CN)

(72) Inventors: Jingang Shi, Beijing (CN); Hui Ma, Beijing (CN); Zhijin Jin, Beijing (CN)

(73) Assignee: E.P.C. (Beijing) Plant Pharmaceutical Technology Co., Ltd., Beijing (CN)

(21) Appl. No.: 13/507,186

(22) Filed: Jun. 12, 2012

Related U.S. Application Data
(60) Provisional application No. 61/496,118, filed on Jun. 13, 2011.
(60) Provisional application No. 61/689,726, filed on Jun. 11, 2012.

(51) Int. Cl. C09B 61/00

(52) U.S. Cl. CPC C09B 61/00
USPC 514/769; 426/540; 514/783; 549/398

(57) ABSTRACT

The invention describes novel aluminum based aqueous anthocyanin solutions, methods to prepare them and the compositions thereof.

### CROSS REFERENCE TO RELATED APPLICATIONS

This application claims benefit of U.S. Provisional Patent Application Ser. No. 61/496,118, filed Jun. 13, 2011, entitled “ANTHOCYANIN BASED COLORANT COMPOSITIONS”; and U.S. Provisional Patent Application Ser. No. TO BE ASSIGNED, filed Jun. 11, 2012, entitled “ANTHOCYANIN BASED COLORANT COMPOSITIONS”; the contents of which are incorporated in their entirety herein by reference.

### FIELD OF THE INVENTION

The invention relates generally to food coloring substances useful, for example in the manufacture of food products, sweets and pharmaceutical products.

### BACKGROUND OF THE INVENTION

Coloring substances containing natural or synthetic coloring substances are commonly used in the manufacturing of food products and pharmaceutical products. A wide range of synthetic coloring substances are commercially available making it possible for the manufacturer of food products, sweets and pharmaceutical products, where a particular color tone is desired, to select a single coloring substance having the desired color or a mixture of coloring substances, which in appropriate combination impart the desired color to the product.

Due to consumer pressure there is a trend to replace the synthetic coloring substances with natural ones. However, the use of natural coloring substances implies various problems such as lack of blue color, acceptable in food substances, unpleasant taste and odor and bleeding, (i.e. diffusion of color from the food into the environment).

Firstly, one problem is that most natural coloring substances used in food products are red, orange or yellow and not blue. There are presently no natural blue coloring substances that are legally approvable for use in foodstuffs marketed in Europe and the USA.

The same problem applies to some extent to green colors. Copper chlorophyll and copper chlorophyllin are efficient and relatively stable green coloring substances but in some countries they are not considered “natural” from a legislation point of view. If a satisfactory natural blue coloring substance could be produced, one might produce a natural green by blending it with a natural yellow color substance like e.g. turmeric.

Another problem by using natural coloring substances for obtaining a blue color is that extracts containing anthocyanins, especially red cabbage extract, are typically associated with unpleasant tastes and odors when applied in food products, sweets and pharmaceutical products which is a disadvantage. Prior references such as Sapers, G M., “Deodorization of a colorant prepared from red cabbage.”, J Food Sci., 47, pp. 972-976, 1982 discloses methods for solving this problem through purification steps However, these methods suffer from being insufficient as the unpleasant tastes and odors often develop after the purification of the anthocyanin has been performed. In conclusion it has so far been technically impossible to permanently remove the organoleptical problems associated with extracts from vegetables such as red cabbage and purple carrot.

Yet an additional problem by using natural coloring substances for obtaining a blue color, is that as anthocyanins are more or less water soluble, they will leak and “bleed” if in an aqueous environment. This is particular a visible problem if used in a multi-compartment food system where the different compartments have different colors.

None of the above references disclose any solution or circumvention to firstly the desire of providing natural blue coloring substances that are legally approvable for use in foodstuffs and are blue at normal food pH values, and secondly the market need of providing a lasting removal of the organoleptical problems associated with extracts from vegetables such as e.g. red cabbage and purple carrot.

Therefore, a need exists for a natural colorings that overcomes one or more of the current disadvantages noted above.

### BRIEF SUMMARY OF THE INVENTION

The present invention surprisingly provides aqueous anthocyanin based colorant compositions, methods to prepare the compositions and their use. The anthocyanin based colorant compositions generally comprise an aqueous food coloring solution which includes an anthocyanin and one or more of 1) an aluminum containing compound and optionally a flavonoid; 2) an excess of aluminum containing compound relative to anthocyanin and optionally a flavonoid; 3) a purified anthocyanin in the presence of one or more of an aluminum containing compound, wherein the aluminum containing compound can be in excess relative to the anthocyanin and optionally a flavonoid ; 4) a specific anthocyanin in the presence of one or more aluminum containing compounds, wherein one or more of the aluminum containing compound can be in excess relative to the anthocyanin and optionally a flavonoid 5) an acetylated anthocyanin in the presence of one or more aluminum containing compounds, wherein one or more of the aluminum containing compound can be in excess relative to the acetylated anthocyanin and optionally a flavonoid.

When a yellow material (such as riboflavin (vitamin B2) safflower yellow, gardenia yellow, citrus yellow, celery yellow, or safflor yellow) is added to one of the above anthocyanin based colorant compositions, a green colored solution can be obtained.

In one aspect, a bicarbonate, such as sodium bicarbonate, is not included in the solutions or compositions of the invention.

The term “flavonoid(s)” is intended to encompass flavonoids (2-phenylchromen-4-one (2-phenyl-1,4-benzopyrone), isoflavonoids (3-phenylchromen-4-one (3-phenyl-1,4-benzopyrone) and neoflavonoids (4-phenylchromen-4-one (3-phenyl-1,4-benzopyrone). Additionally, flavonoids include flavone glycosides and flavonoid derivatives. Suitable flavanols include rutin and quercitrin. A suitable source of flavonoids is from celery extract.

A unique feature among the anthocyanin compositions is that they retain their bluish/purple color at low pH, e.g., from about 2 to about 4, which is unusual and unexpected. Generally, a “red” flavylium complex is formed and visualized at pH values below about 5. Blue color is generally imparted as the pH is raised to form an anhydrobase of an anthocyanin, at a pH of approximately 5 or 6.

In another aspect, an aqueous anthocyanin based colorant composition, optionally with a flavonoid, is prepared by a procedure, whereby an aluminum containing compound is combined with the food coloring substances, followed by adjustment of the pH to a value of from about 2 to about 8, preferably from 4 to about 7.5.

Also surprisingly, it has been found that the desire and need mentioned above can be met by preparation of an aluminum containing composition of the food colorants. The aluminum containing composition may be prepared by combining an aluminum containing compound with the food coloring substances, e.g., an anthocyanin and, optionally, a flavonoid, followed by adjustment of the pH to a value of from about 2 to about 8, preferably from about 3 to about 5, to cause desired color formation.

Additional aspects of the disclosure pertain to (1) purified red cabbage extract and/or the specific components in such extract; (2) combinations of the extract of (1) and an aluminum compound, which exhibit a blue color at a pH of≧about 2; the combination itself does not necessarily have a pH of≧about 2 and does not necessarily need to be in a solution; and (3) color compositions comprising the combination of (2) with other color substances to exhibit a green color, a grape red color, etc. in a solution, also, the composition of (3) itself is independent of pH and does not necessarily be a solution.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed descriptions are to be regarded as illustrative in nature and not restrictive.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 provides excellent blue colored aqueous solutions over a pH range of 2.3-4.0 wherein an anthocyanin containing compound (red cabbage extract) was combined with an aluminum containing compound.

FIG. 2 demonstrates that an anthocyanin containing compound (red cabbage extract) when combined with an aluminum containing compound exhibited a blue color in an aqueous solution at a pH of 3, whereas a comparative sample prepared according to U.S. Pat. No. 7,279,189 that further contained sodium bicarbonate and was prepared from conventional red cabbage extract not enriched by acylated anthocyanins, provided an aqueous red solution.

FIG. 3 demonstrates that an anthocyanin containing compound (red cabbage extract) when combined with an aluminum containing compound exhibited a blue color in an aqueous solution at a pH of 3.5, whereas a comparative sample prepared according to U.S. Pat. No. 7,279,189 that further contained sodium bicarbonate and was prepared from conventional red cabbage extract not enriched by acylated anthocyanins, provided an aqueous red solution.

FIG. 4 demonstrates that an anthocyanin containing compound (red cabbage extract) when combined with an aluminum containing compound exhibited a blue color in an aqueous solution at a pH of 3.7, whereas a comparative sample prepared according to U.S. Pat. No. 7,279,189 that further contained sodium bicarbonate and was prepared from conventional red cabbage extract not enriched by acylated anthocyanins, provided an aqueous red solution.

FIG. 5 provides yellow to green colored solutions based on the combination of a blue anthocyanin containing compound (red cabbage extract), an aluminum containing compound and a yellow coloring substance (riboflavin) at a pH range of 5.0 at differing ratios of blue to yellow concentrations.

FIG. 6 provides that a green color can be obtained at low pH by properly compounding a blue coloring solution according to the present invention in combination with a yellow coloring substance (riboflavin).

FIG. 7 is an HPLC of the purified red cabbage extract.

FIG. 8 provides mass spectral information identifying the isolated/purified compounds within the red cabbage extract of FIG. 7.

FIG. 9 is an HPLC of fresh red cabbage, i.e. FIG. 9 represents naturally occurring components of red cabbage and their contents. FIG. 9 demonstrates that fresh red cabbage contains a large amount of non-acylated anthocyanins.

FIG. 10 is the HPLC (UV detector with wavelength of 520 nm) of the purified red cabbage as described in Example 5.

FIG. 11 is the HPLC-MS of the purified red cabbage as described in Example 5.

FIGS. 12 through 20 are mass spectra of the specific components of the red cabbage extract of Example 5 and noted in FIGS. 10 and 11 as described herein.

### DETAILED DESCRIPTION

In the specification and in the claims, the terms “including” and “comprising” are open-ended terms and should be interpreted to mean “including, but not limited to . . . ” These terms encompass the more restrictive terms “consisting essentially of” and “consisting of.”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

In one embodiment, the food coloring substance is an extract of red cabbage, purple carrot, sweet potato, black carrot, black rice, bilberry, red radish, aronia, elderberry or black currant.

In a particularly preferred embodiment, the food coloring substances are combinations of an extract of purple carrot, a red cabbage extract, or bilberry extract and riboflavin or safflor material.

In one aspect, the compositions described herein are substances which may be added to food products, sweets, confectionary, beverages, pharmaceuticals and similar other products to be ingested orally.

Likewise, food products in the present context is to be understood as any edible product comprising nutrients, sweets, confectionary, beverages and pharmaceuticals.

A further aspect of the invention provides a process for producing a food coloring substance (e.g. an anthocyanin), having a blue color at a pH of greater than or equal to 2, more preferably in the range of from about 2 to about 7, preferably from about 2 to about 6, more preferably from about 2 to about 3.6, which process comprises treating a food coloring substance which contains an anthocyanin compound (as further described herein) with an aluminum compound, and adjusting the pH to a value of from greater than or equal to 2, to produce an aqueous anthocyanin based colorant composition comprising the anthocyanin compound. Optionally, riboflavin or a safflor composition can be added to the anthocyanin based colorant composition to provide a green colored solution. Additionally, a flavonoid can be further included in the composition. In one embodiment, an acetylated anthocyanin is treated with an aluminum compound in the presence of a flavonoid, such as those found in celery extract. Addition of a flavonoid to a blue colored anthocyanin composition/solution provides a green solution/composition.

The adjustment of the pH can be done after the anthocyanin and, optionally, the riboflavin, safflor or flavonoid have been combined with the aluminum compound. An example is a process wherein the materials are combined with a solution or suspension of an aluminum compound, and the pH is then maintained at or below a pH of about 8.

In certain aspects, it has been surprisingly found that a large excess of an aluminum compound, e.g., about a 30 molar ratio of Al³⁺, in particular a provides an exceptional colored solution.

In certain aspects, the colored solutions of the present invention can be subjected to a drying treatment, such as freeze drying or spray drying, to afford a powdered material.

Food coloring substances typically characterized by having unpleasant taste and/or odor properties are in particular anthocyanins, in particular, an anthocyanin of the general formula:

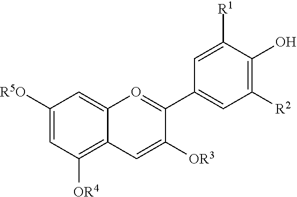

wherein R¹ and R² are each independently H, OH or OCH₃, and R³, R⁴ and R⁵ are each independently H, a sugar residue or an acylated sugar residue.

The sugar residues are most commonly residues derived from glucose, galactose, xylose, arabinose and rhamnose; substitution with disaccharides also occurs e.g. rutinose, sophorose, sambubiose, and gentiobiose. These residues are examples only and are not to be understood as a complete list.

The term “anthocyanin”, therefore encompasses water soluble pigments that are generally red, purple or blue, depending on pH. Anthocyanins are the glucosides of anthocyanidins.

Anthocyanidins are generally flavylium cation derivatives of anthocyanins (devoid of the sugar moit(ies)) and include aurantinidin, cyanidin, dephininidin, europinidin, luteolinidin, pelargonidin, malvidin, peonidin, petunidin and rosinidin, for example.

“Acylated” anthocyanins, therefore, are anthocyanins wherein the sugar residue has been acetylated at one or more positions, generally as an acetate.

“Acylated anthocyanidins, refer to anthocyanidins (the aglycone of an anthocyanin)

The term “proanthocyanin”, is an oligomer or polymer of an anthocyanin. Consequently, an “acylated proanthocyanin” is an oligomer or a polymer of an anthocyanin that is acetylated at one or more positions.

The term, “proanthocyanidin”, is an oligomer or polymer of an anthocyanidin. Similarly, an “acylated proanthocyanidin” is an oligomer or a polymer of an anthocyanidin that is acetylated at one or more positions.

A particularly advantageous feature of the anthocyanin-based products of the present invention is that the blue to green color of the anthocyanin colorant is retained at pHs of greater than or equal to 2, more preferably in the range of from about 2 to about 7, preferably from about 2 to about 6, more preferably from about 2 to about 3.6.

The anthocyanin extracts described herein are purified or are considered isolated from the naturally occurring red cabbage plant material. As such, 11 compounds have been identified by extraction, isolation, purification and/or characterization by HPLC, UV and/or mass spectral analysis. As such, the present invention provides purified materials having a purity of at least 90%, ideally 95%, more ideally 98% most ideally 99% or greater. Thus, the term “purified” as used herein does not require absolute purity; rather, it is intended as a relative term. For example, a purified substance can be one in which the subject substance is at a higher concentration than the substance would be in its natural environment, e.g., within the raw cabbage. For example, a red cabbage extract component can be considered purified if the content in the preparation represents at least 50%, 60%, 70%, 80%, 85%, 90%, 92%, 95%, 98%, or 99% of the total content of the preparation.

The present invention provides 11 components of the red cabbage extract. Thus, the 11 components have been isolated, purified and/or identified as being components of the red cabbage extract. It is considered that the each component, each and by itself, is important and also that the combination of the components provides for the unique blue color of the aluminum complexes/compositions described herein.

The term “enriched” refers to a material, such as an extract, e.g., red cabbage extract, that has been subjected to a process to increase amounts of one or more components of the plant relative to the percentages that occur naturally in the plant. For example, the red cabbage extract described herein is enriched in about 10 or 11 components of those in the naturally occurring untreated red cabbage. It has been found that, in particular, two components appear to be major components of the extract after the red cabbage is subjected to the process conditions described herein.

The following paragraphs enumerated consecutively from 1 through 15 provide for various aspects of the present invention. In one embodiment, in a first paragraph (1), the present invention provides an anthocyanin based colorant composition, comprising a food coloring substance which includes an aqueous solution of an anthocyanin combined with an aluminum containing compound in a pH range of greater than or equal to 2, more preferably in the range of from about 2 to about 7, preferably from about 2 to about 6, more preferably from about 2 to about 3.6 to form a blue colored solution.

2. The anthocyanin based colorant composition of paragraph 1, wherein the food coloring substance is an anthocyanin, acylated anthocyanin, anthocyanidin, acylated anthocyanidin, proanthocyanin, acylated proanthocyanin, proanthocyanidin, acylated proanthocyanidin, derivatives thereof, condensation products thereof and hydrates thereof.

3. A anthocyanin based colorant composition of paragraph 1 or 2, wherein the anthocyanin compound has the formula:

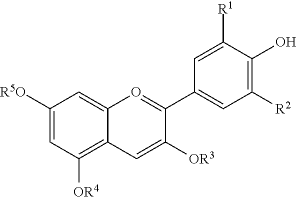

wherein R¹ and R² are each independently H, OH or OCH₃, and R³, R⁴ and R⁵ are each independently H, a sugar residue or an acylated sugar residue.

4. The anthocyanin based colorant composition of any of paragraphs 1 through 3, wherein the anthocyanin compound originates from plant parts other than petals or sepals.

5. The anthocyanin based colorant composition of paragraph 4, wherein the food coloring substance is an extract of red cabbage, purple carrot, sweet potato, black carrot, black rice, bilberry, or black currant.

6. The anthocyanin based colorant composition of any of paragraphs 1 through 5, wherein the aluminum containing compound is an aluminum halide, aluminum sulfate, and/or a potassium aluminum sulfate.

7. The anthocyanin based colorant composition of any of paragraphs 1 through 6, wherein the molar ratio of aluminum containing compound to anthocyanin is from about 1:100 to about 100:1.

8. The anthocyanin based colorant composition of any of paragraphs 1 through 7, further comprising a yellow plant extract to provide a green colored solution.

9. The anthocyanin based colorant composition of paragraph 8, wherein the yellow plant extract is riboflavin or safflor extract or combinations thereof.

10. The anthocyanin based colorant composition of either paragraphs 8 or 9, wherein the ratio of anthocyanin to yellow plant extract is from about 1:100 to about 100:1 on a molar basis.

11. The anthocyanin based colorant composition of any of paragraphs 1 through 7, further comprising a flavonoid.

12. The anthocyanin based colorant composition of paragraph 11, wherein the flavonoid is a celery extract which produces a green solution.

13. The anthocyanin based colorant composition of paragraph 11, wherein the flavonoid is derived from 2-phenylchromen-4-one, 3-phenylchromen-4-one or 4-phenylchromen-4-one.

14. The anthocyanin based colorant composition of any of paragraphs 1 through 13, wherein the solution is removed to afford a blue or green solid.

15. The anthocyanin based colorant composition of paragraph 14, wherein the removal of solution is by freeze drying or by spraying.

The following paragraphs enumerated consecutively from 1 through 47 also provide for various aspects of the present invention. In one embodiment, in a first paragraph (1), the present invention provide an anthocyanin based colorant composition, comprising a food coloring substance which includes one or more anthocyanin compound(s) combined with an aluminum containing compound in a pH range of greater than or equal to 2, more preferably in the range of from about 2 to about 7, preferably from about 2 to about 6, more preferably from about 2 to about 3.6.

2. The anthocyanin based colorant composition of paragraph 1, wherein the anthocyanin compound is an acylated anthocyanin, an anthocyanidin, an acylated anthocyanidin, a proanthocyanin, an acylated proanthocyanin, a proanthocyanidin, an acylated proanthocyanidin, derivatives thereof, condensation products thereof, hydrates thereof, or mixtures thereof

3. The anthocyanin based colorant composition of paragraph 1 or 2, wherein the anthocyanin compound is selected from those having the formula:

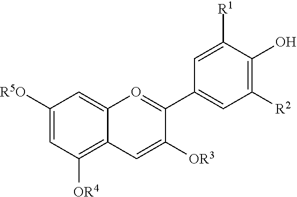

wherein R¹ and R² are each independently H, OH or OCH₃, and R³, R⁴ and R⁵ are each independently H, a sugar residue or an acylated sugar residue.

4. The anthocyanin based colorant composition of any of paragraphs 1 through 3, wherein the acylated anthocyanin is a monoacylated anthocyanin and/or a diacetylated anthocyanin.

5. The anthocyanin based colorant composition of any of paragraphs 1 through 4, wherein the anthocyanin compound is Cyan-3(caf)(sin)soph-5-glu, Cyan-3(sin)triglu-5-glu, Cyan-3(sin)(p-coum)triglu-5-glu, Cyan-3(sin)(sin)soph-5-glu, Cyan-3(sin)(fer)triglu-5-glu, Cyan-3(sin)soph-5-glu, Cyan-3(fer)soph-5-glu, Cyan-3(p-coum)glu-5-glu, Cyan-3(sin)(sin)soph-5-glu,Cyan-3(sin)(fer)soph-5-glu, Cyan-3(sin)(p-coum)soph-5-glu or mixtures thereof.

6. The anthocyanin based colorant composition of any of paragraphs 1 through 5, wherein the anthocyanin compound originates from plant parts other than petals or sepals.

7. The anthocyanin based colorant composition of paragraph 6, wherein the food coloring substance is an extract of red cabbage, purple carrot, sweet potato, black carrot, black rice, bilberry, red radish, aronia, elderberry or black currant.

8. The anthocyanin based colorant composition of any of paragraphs 1 through 7, wherein the food coloring substance is an acylated anthocyanin enriched red cabbage extract.

9. The anthocyanin based colorant composition of any of paragraphs 1 through 8, wherein the aluminum containing compound is an aluminum halide, aluminum sulfate, and/or a potassium aluminum sulfate.

10. The anthocyanin based colorant composition of any of paragraphs 1 through 9, wherein the molar ratio of aluminum containing compound to anthocyanin is from about 1:100 to about 100 :1.

11. The anthocyanin based colorant composition of any of paragraphs 1 through 10, further comprising a yellow coloring substance to provide a green color.

12. The anthocyanin based colorant composition of paragraph 11, wherein the yellow coloring substance is riboflavin (vitamin B2).

13. The anthocyanin based colorant composition of paragraph 11, wherein the yellow coloring substance is a yellow plant extract.

14. The anthocyanin based colorant composition of paragraph 13, wherein the yellow plant extract is safflower yellow, gardenia yellow, citrus yellow, celery yellow, saffron extract or combinations thereof.

15. The anthocyanin based colorant composition of either paragraph 13 or 14, wherein the ratio of anthocyanin to yellow plant extract is from about 50:1 to about 1:50 on a weight basis.

16. The anthocyanin based colorant composition of any of paragraphs 1 through 10, further comprising a red coloring substance to provide a pomegranate red color and/or a grape red color.

17. The anthocyanin based colorant composition of paragraph 16, wherein the red coloring substance is red plant extract.

18. The anthocyanin based colorant composition of paragraph 17, wherein the red plant extract is elderberry extract and/or aronia extract.

19. The anthocyanin based colorant composition of any of paragraphs 1 through 10, further comprising a red coloring substance and a yellow coloring substance to provide a caramel color.

20. The anthocyanin based colorant composition of paragraph 19, wherein the red coloring substance is red plant extract, and/or the yellow coloring substance is yellow plant extract.

21. The anthocyanin based colorant composition of paragraph 20, wherein the red plant extract is elderberry extract and/or aronia extract, and the yellow plant extract is safflower yellow, gardenia yellow, citrus yellow, celery yellow, saffron extract or combinations thereof.

22. The anthocyanin based colorant composition of any of paragraphs 1 through 10, further comprising a flavonoid.

23. The anthocyanin based colorant composition of paragraph 22, wherein the flavonoid is a celery extract.

24. The anthocyanin based colorant composition of paragraph 23, wherein the flavonoid is derived from 2-phenylchromen-4-one, 3-phenylchromen-4-one or 4-phenylchromen-4-one.

25. The anthocyanin based colorant composition of any of paragraphs 1 through 24, in the form of a solution.

26. The anthocyanin based colorant composition of any of paragraphs 1 through 24, in the form of a solid.

27. The anthocyanin based colorant composition of paragraph 26, wherein the solid is obtained by removing the solvent from the solution by freeze drying or spray drying.

28. Acylated anthocyanin-enriched red cabbage extract.

29. The acylated anthocyanin-enriched red cabbage extract according to paragraph 28, wherein the acylated anthocyanin is a mono acylated anthocyanin and/or a diacylated anthocyanin.

30. The acylated anthocyanin-enriched red cabbage extract according to paragraph 28, wherein the acylated anthocyanin extract comprises Cyan-3(caf)(sin)soph-5-glu, Cyan-3(sin)triglu-5-glu, Cyan-3(sin)(p-coum)triglu-5-glu, Cyan-3(sin)(sin)soph-5-glu, Cyan-3(sin)(fer)triglu-5-glu, Cyan-3(sin)soph-5-glu, Cyan-3(fer)soph-5-glu, Cyan-3(p-coum)glu-5-glu, Cyan-3(sin)(sin)soph-5-glu, Cyan-3(sin)(fer)soph-5-glu, Cyan-3(sin)(p-coum)soph-5-glu, or mixtures thereof.

31. The anthocyanin based colorant composition of any of paragraphs 1 through 27, wherein the combination of the anthocyanin and aluminum containing compound is characterized by forming a blue colored solution in a pH range of greater than or equal to 2, more preferably in the range of from about 2 to about 7, preferably from about 2 to about 6, more preferably from about 2 to about 3.6.

32. A blue anthocyanin based colorant composition, comprising a food coloring substance which includes one or more anthocyanin compound(s) combined with an aluminum containing compound, wherein the blue colorant composition, when dissolved in water, having a pH range of greater than or equal to 2, more preferably in the range of from about 2 to about 7, preferably from about 2 to about 6, more preferably from about 2 to about 3.6.

33. A blue anthocyanin based colorant composition, comprising a food coloring substance which includes one or more anthocyanin compound(s) combined with an aluminum containing compound, wherein the blue colorant composition, when dissolved in water, provides an aqueous solution that has a pH range from acidic to neutral.

34. A blue anthocyanin based colorant composition comprising one or more of Cyan-3(caf)(sin)soph-5-glu, Cyan-3(sin)triglu-5-glu, Cyan-3(sin)(p-coum)triglu-5-glu, Cyan-3(sin)(sin)soph-5-glu, Cyan-3(sin)(fer)triglu-5-glu, Cyan-3(sin)soph-5-glu, Cyan-3(fer)soph-5-glu, Cyan-3(p-coum)glu-5-glu, Cyan-3(sin)(sin)soph-5-glu, Cyan-3(sin)(fer)soph-5-glu, Cyan-3(sin)(p-coum)soph-5-glu, or mixtures thereof and an aluminum containing compound.

35. A blue anthocyanin based colorant composition, comprising Cyan-3(sin)soph-5-glu), (Cyan-3(sin)(sin)soph-5-glu) or both, and an aluminum compound.

36. The blue anthocyanin based colorant composition of paragraph 35 further comprising one or more of Cyan-3(caf)(sin)soph-5-glu diacyl, Cyan-3(sin)triglu-5-glu monoacyl, Cyan-3(sin)(p-coum)triglu-5-glu diacyl, Cyan-3(sin)(sin)soph-5-glu diacyl, Cyan-3(sin)(fer)triglu-5-glu diacyl, Cyan-3(fer)soph-5-glu monacyl, Cyan-3(p-coum)glu-5-glu monoacyl, Cyan-3(sin)(fer)soph-5-glu diacyl or Cyan-3(sin)(p-coum)soph-5-glu diacyl.

37. The blue anthocyanin based colorant composition of paragraph 35, wherein Cyan-3(sin)soph-5-glu) and/or (Cyan-3(sin)(sin)soph-5-glu) are present from about 0 to 100 percent by weight.

38. The blue anthocyanin based colorant composition of paragraph 37, wherein one or more of Cyan-3(caf)(sin)soph-5-glu diacyl, Cyan-3(sin)triglu-5-glu monoacyl, Cyan-3(sin)(p-coum)triglu-5-glu diacyl, Cyan-3(sin)(sin)soph-5-glu diacyl, Cyan-3(sin)(fer)triglu-5-glu diacyl, Cyan-3(fer)soph-5-glu monacyl, Cyan-3(p-coum)glu-5-glu monoacyl, Cyan-3(sin)(fer)soph-5-glu diacyl or Cyan-3(sin)(p-coum)soph-5-glu diacyl are present in an amount of from greater than 0 weight percent to about 20 percent by weight based on 100 weight percent.

39. The blue anthocyanin based colorant of paragraph 37, further comprising Cyan-3(caf)(sin)soph-5-glu diacyl in an amount of from greater than 0 weight percent to about 20 percent by weight based on 100 weight percent.

40. The blue anthocyanin based colorant of paragraph 37, further comprising Cyan-3(sin)triglu-5-glu monoacyl in an amount of from greater than 0 weight percent to about 20 percent by weight based on 100 weight percent.

41. The blue anthocyanin based colorant of paragraph 37, further comprising Cyan-3(sin)(p-coum)triglu-5-glu diacyl in an amount of from greater than 0 weight percent to about 20 percent by weight based on 100 weight percent.

42. The blue anthocyanin based colorant of paragraph 37, further comprising Cyan-3(sin)(sin)soph-5-glu diacyl in an amount of from greater than 0 weight percent to about 20 percent by weight based on 100 weight percent.

43. The blue anthocyanin based colorant of paragraph 37, further comprising Cyan-3(sin)(fer)triglu-5-glu diacyl in an amount of from greater than 0 weight percent to about 20 percent by weight based on 100 weight percent.

44. The blue anthocyanin based colorant of paragraph 37, further comprising Cyan-3(fer)soph-5-glu monacyl in an amount of from greater than 0 weight percent to about 20 percent by weight based on 100 weight percent.

45. The blue anthocyanin based colorant of paragraph 37, further comprising Cyan-3(p-coum)glu-5-glu monoacyl in an amount of from greater than 0 weight percent to about 20 percent by weight based on 100 weight percent.

46. The blue anthocyanin based colorant of paragraph 37, further comprising Cyan-3(sin)(fer)soph-5-glu diacyl in an amount of from greater than 0 weight percent to about 20 percent by weight based on 100 weight percent.

47. The blue anthocyanin based colorant of paragraph 37, further comprising Cyan-3(sin)(p-coum)soph-5-glu diacyl in an amount of from greater than 0 weight percent to about 20 percent by weight based on 100 weight percent.

The invention will be further described with reference to the following non-limiting Examples. It will be apparent to those skilled in the art that many changes can be made in the embodiments described without departing from the scope of the present invention. Thus the scope of the present invention should not be limited to the embodiments described in this application, but only by embodiments described by the language of the claims and the equivalents of those embodiments. Unless otherwise indicated, all percentages are by weight.

### EXAMPLES

### Example 1

0.1 mg purified acylated anthocyanin (sweet potato extract) was combined with 0.5 mg safflor yellow/ml in 1 ml buffer pH 7.5 (0.1 M potassium phosphate buffer). To this was added 1 mg AlCl₃/ml to afford a green solution. The green solution could be concentrated by spray drying to provide a green powder.

### Example 2

0.1 mg purified acylated anthocyanin (sweet potato extract) was combined with 0.5 mg celery extract and 1 mg AlCl₃ at pH=7.0 (0.1 M potassium phosphate buffer). The solution turned a brilliant green.

### Example 3

0.1 g purified red cabbage anthocyanins (acylated anthocyanins) was combined with 0.1 M potassium phosphate buffer (pH=4.0) and 0.1 mg AlCl₃ to provide a blue solution.

### Example 4

0.1 mg purified acylated anthocyanin (red cabbage extract) was combined with 60 μg riboflavin/mL in 1 mL potassium phosphate buffer (1 M, pH 4.5) by addition of 1 mg AlCl₃ to provide a green colored solution.

### Example 5

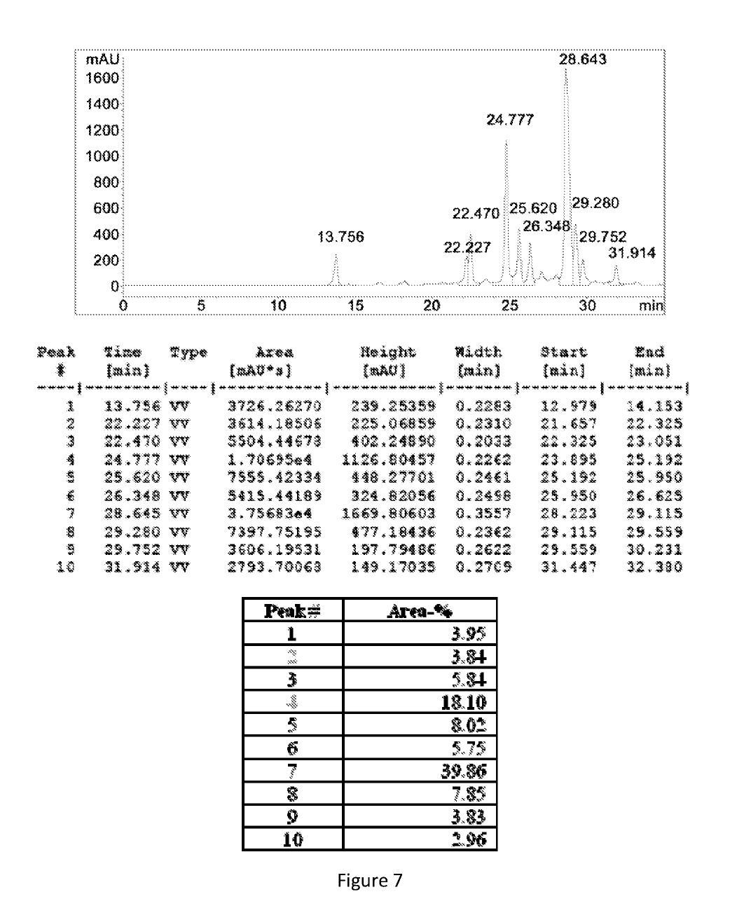

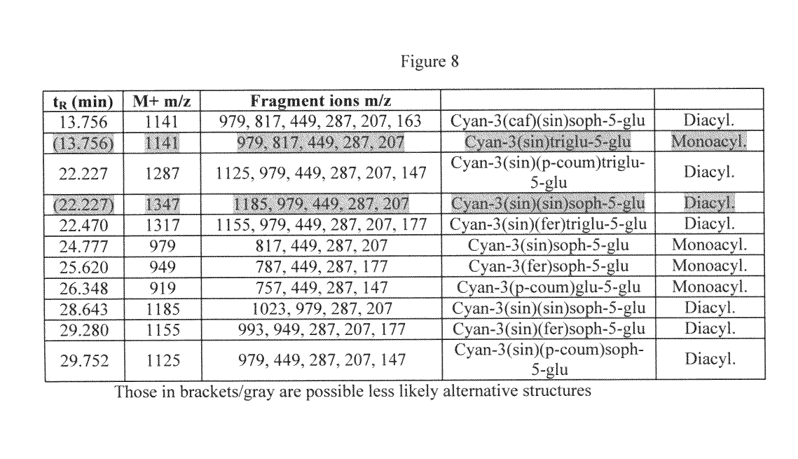

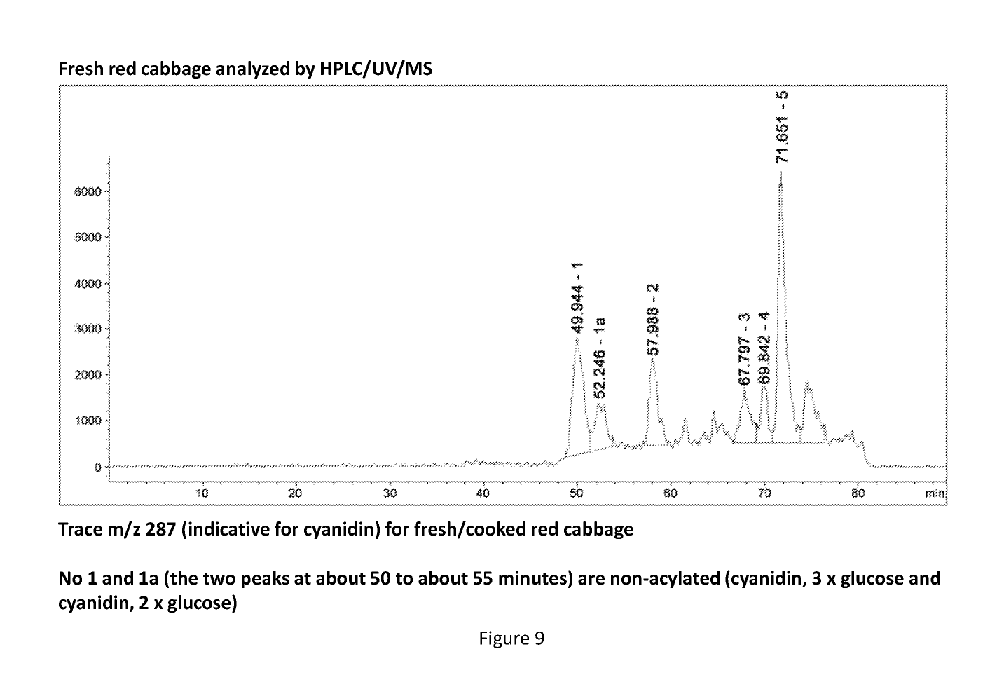

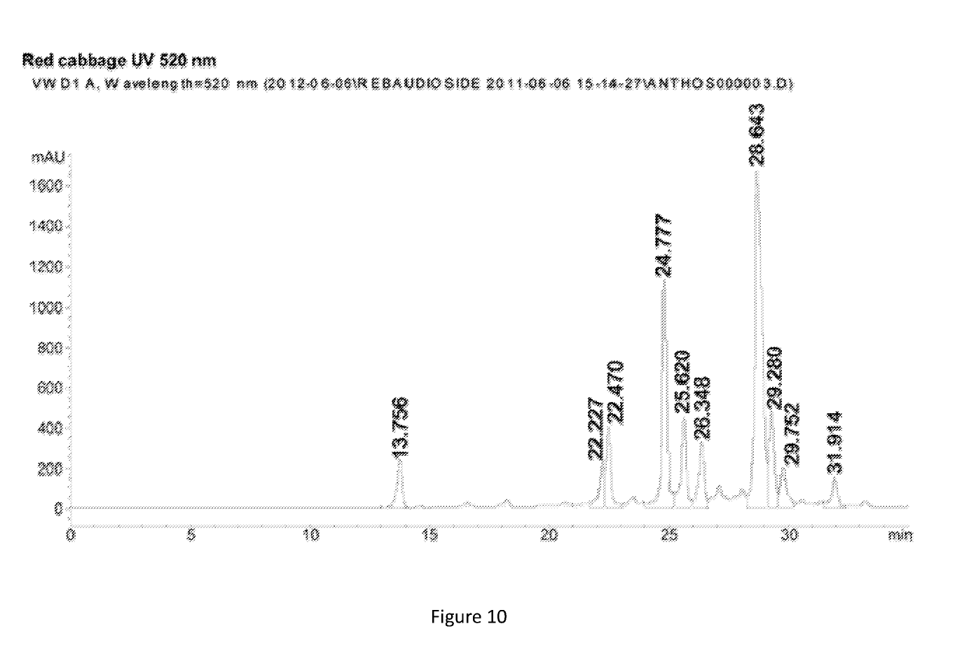

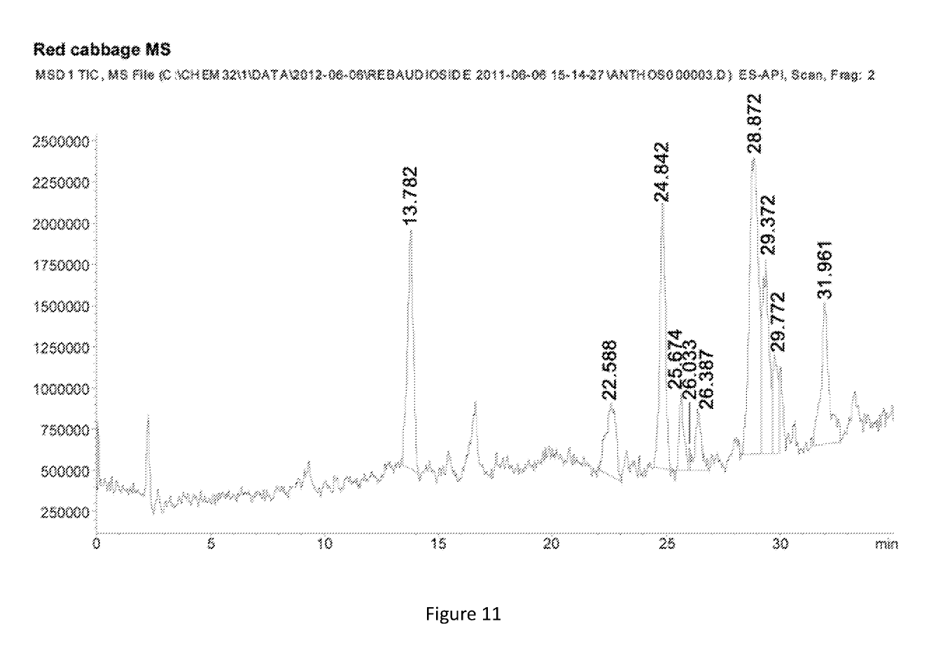

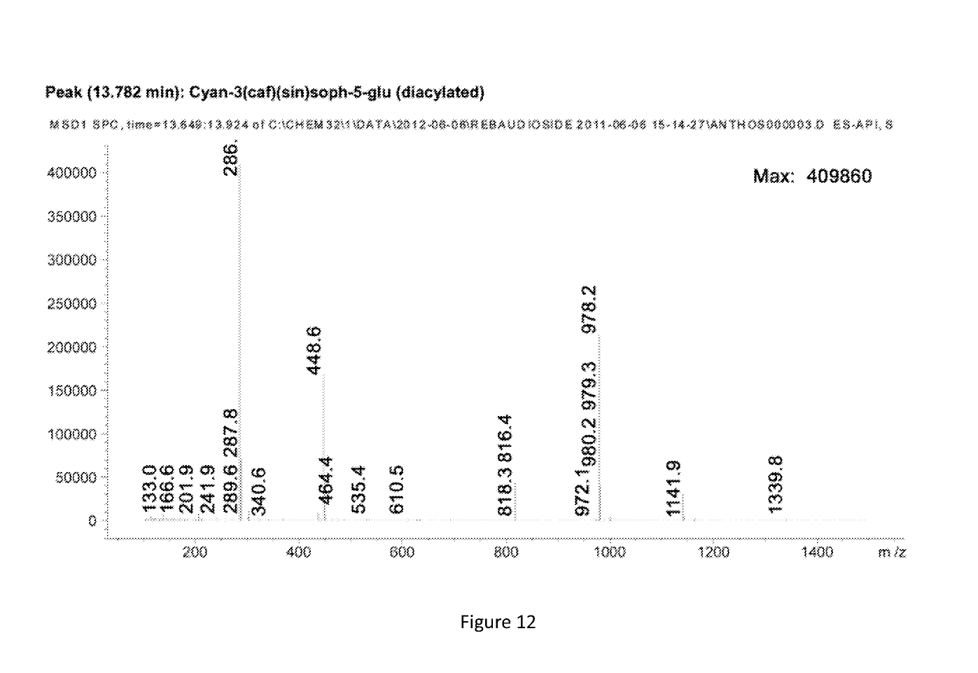

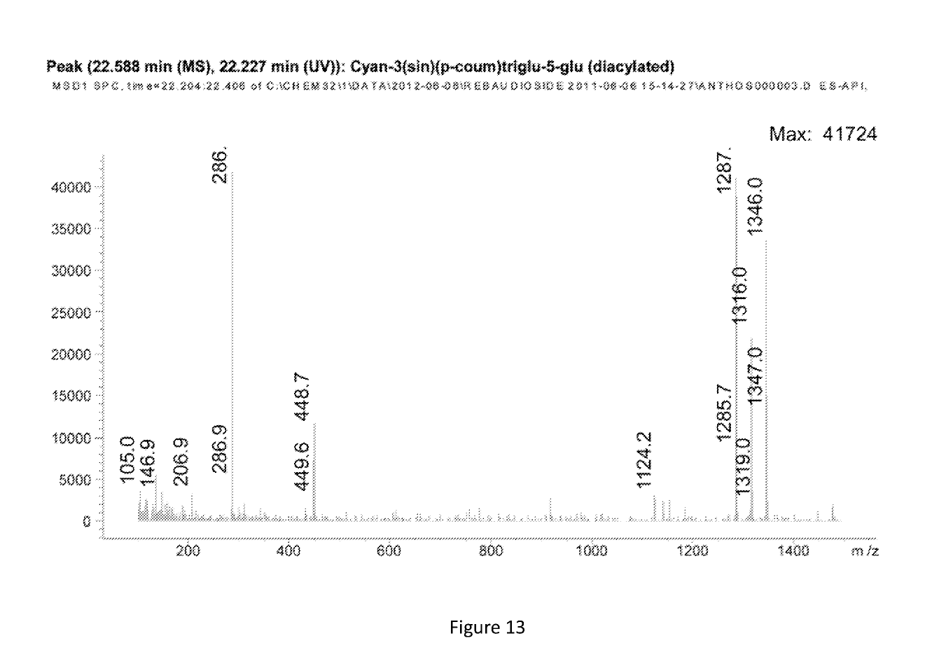

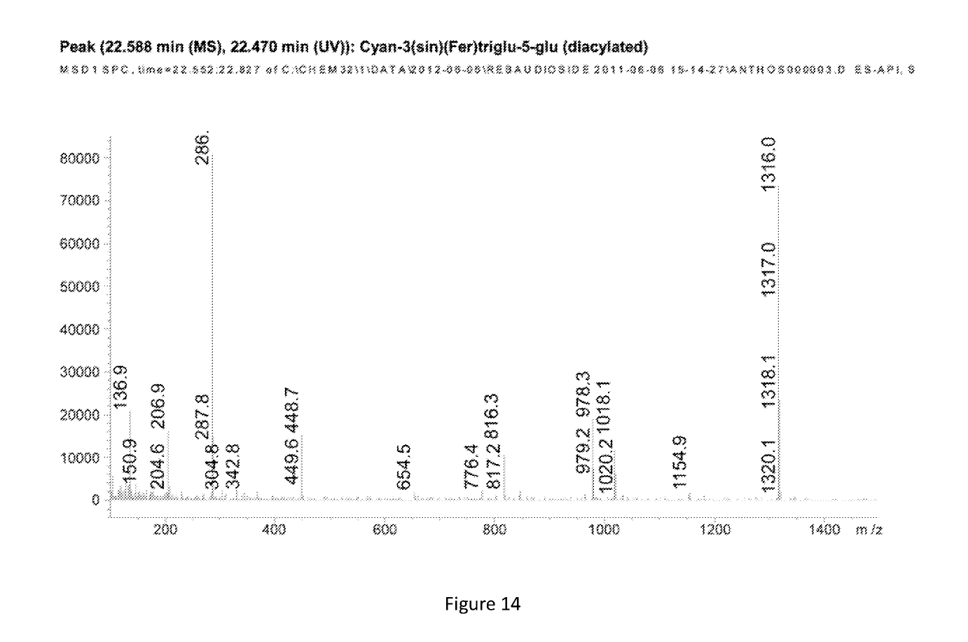

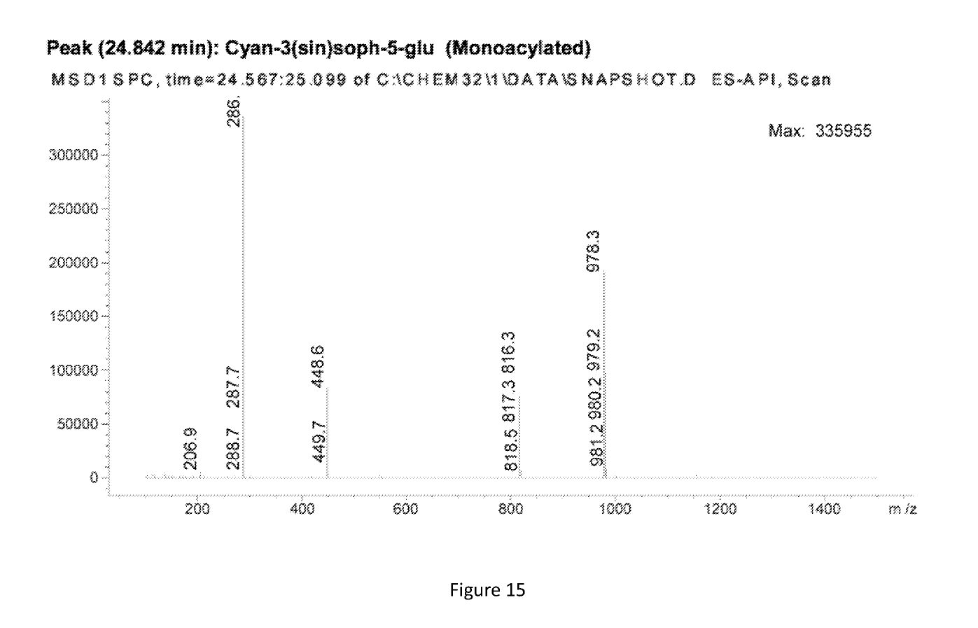

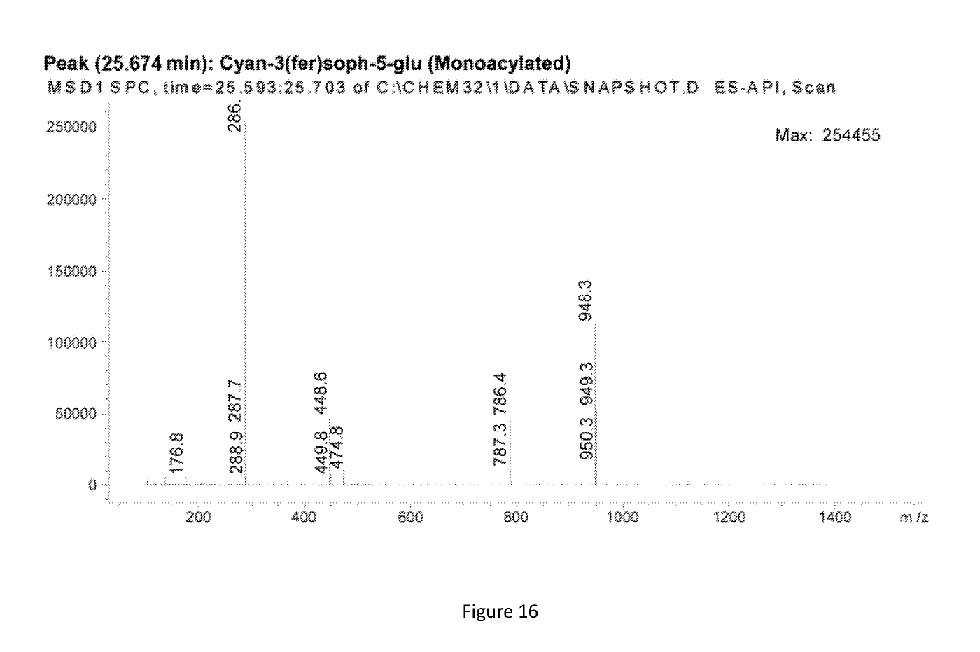

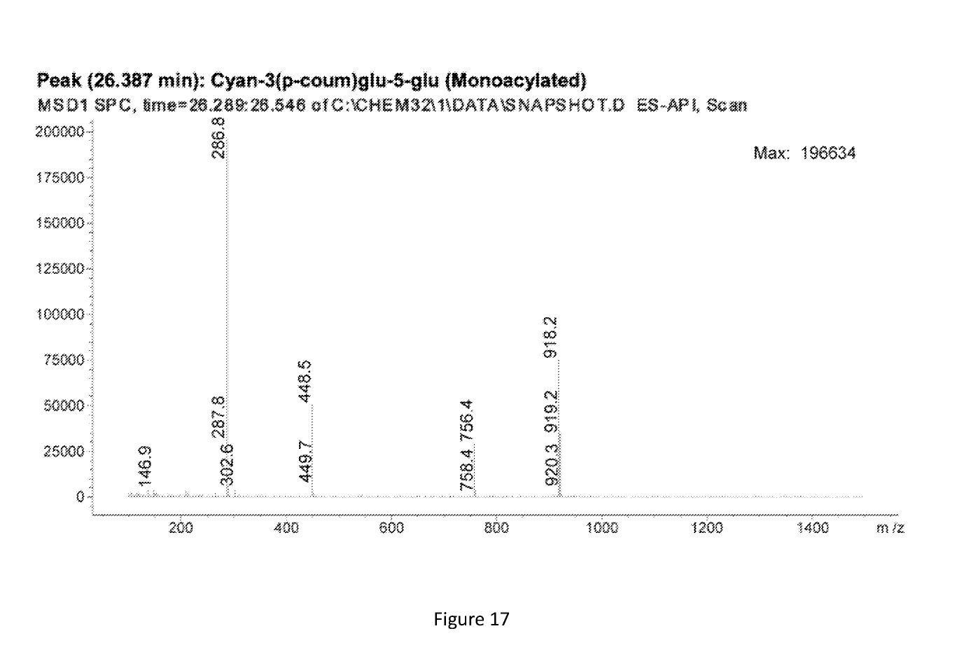

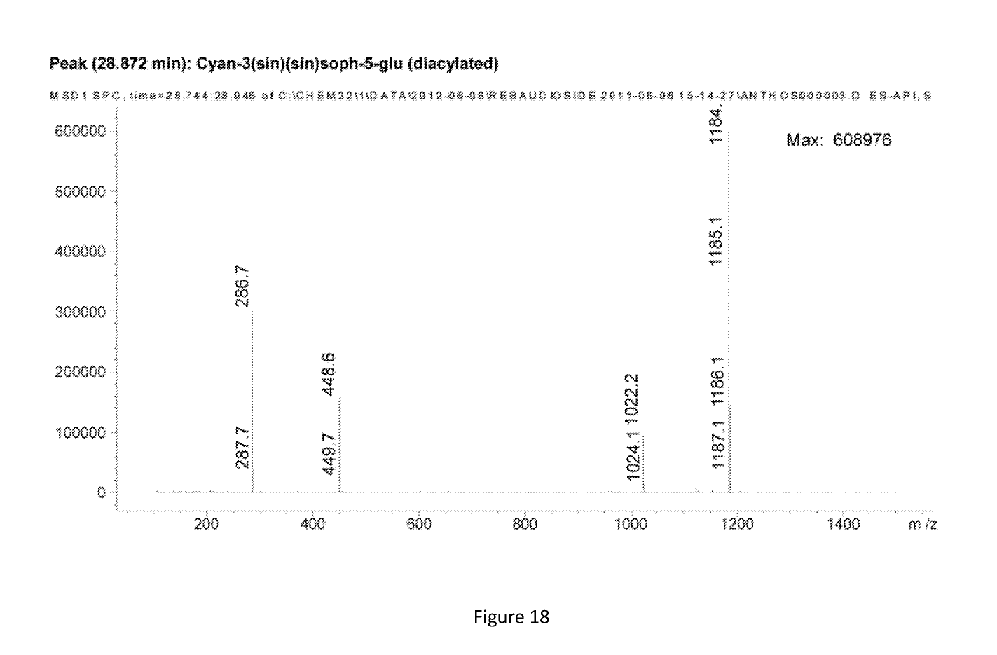

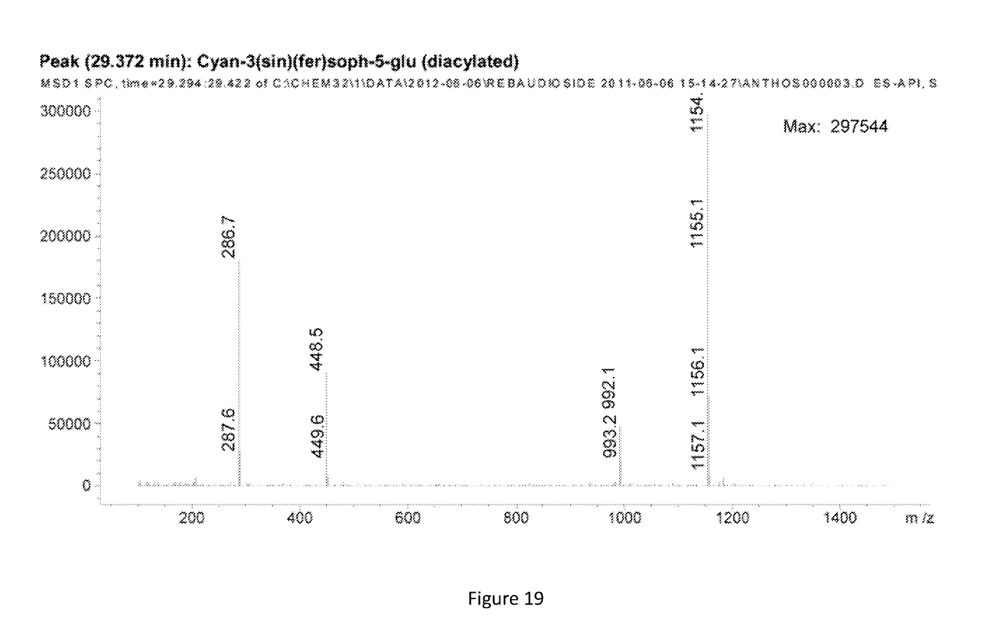

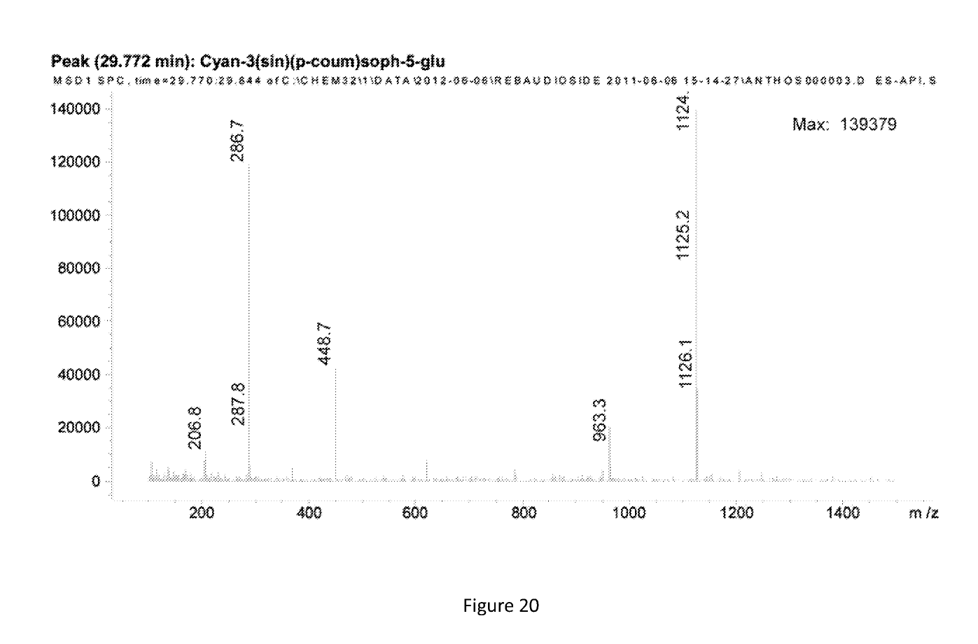

Preparation of Purified Red Cabbage Extract 12 g red cabbage extract (Wuhan Green Food Biological Engineering Co. Ltd., Lot: WGFC110930(II)) was loaded on 500 g Amerlite XAD-7HP (Rohm & Haas, Φ70 mm*120 mm), and was eluted with 1 L of 10%, 20%, 30%, and 40% aqueous ethanol solution sequentially. The 30% ethanol fraction and 40% ethanol fraction were combined and concentrated. The concentrate was then spray dried to obtain purified red cabbage extract powder. FIG. 7 is an HPLC of the purified red cabbage extract. FIG. 8 provides mass spectral information identifying the isolated/purified compounds within the red cabbage extract of FIG. 7. FIG. 9 is an HPLC of fresh red cabbage, i.e. FIG. 9 represents naturally occurring components of red cabbage and their contents. FIG. 9 demonstrates that fresh red cabbage contains a large amount of non-acylated anthocyanins. FIG. 10 is the HPLC (UV detector with wavelength of 520 nm) of the purified red cabbage as described above. FIG. 11 is the HPLC-MS of the purified red cabbage as described above. FIGS. 12 through 20 are mass spectra of the specific components of the red cabbage extract described above and noted in FIGS. 10 and 11 as described herein.

The following abbreviations are used throughout.

Sin . . . sinapoyl

Caf . . . caffeoyl

Fer . . . feruloyl

Coum . . . coumaroyl

Glu . . . glucosyl

Soph . . . sophoryl

Triglu . . . tri-glucosyl residue

Cyan . . . cyanidin

Diacyl . . . Diacylated

Monoacyl . . . monoacylated

Determination of Total Anthocyanins Contents in the purified Red Cabbage Extract

UV Method

1.1. Instruments:

| | |
|---|---|
| UV system | Shimadzu 1700 |
| Analytical balance | Sartorius BP211D |
| Volumetric flask | 100 ml, 50 ml |

1.2. Reagent:

| | |
|---|---|
| MeOH | A.R. (analytical reagent) |
| HCl | A.R. (concentrated, 37%) |

2% HCL-MeOH: hydrochloric acid (37%) 56 ml, added in a 1000 ml volumetric flask, and diluted to volume with MeOH

1.3 Sample: Cabbage Red powder EPC-003-37-01 (The purified product prepared in Example 5)

1.4. Analysis condition: X=539 nm

1.5. Analysis procedure:

1.5.1 Preparation of sample solution

0.1 g of sample was weighed, 60 ml 2% HCL-MeOH was added, the mixture was treated for 30 min at 80° C. After cooling to room temperature, the cooled solution was transferred into a 100 ml volumetric flask, and diluted to volume with 2% HCL-MeOH. A 1 ml diluted sample was added into a 50 ml volumetric bottle, and diluted to volume with 2% HCl-MeOH.

1.5.2 Analysis:

Absorption(A) of samples was determined at λ=539 nm, with 2% HCL-MeOH as reference.

1.6. Calculation of anthocyandins content:

$$content \% = \frac{A \times {F}_{dilute}}{{E}_{coeff} \times {W}_{( g )} \times 100} \times 100 \%$$

A: absorption of sample solution

F_{dilute}: dilution factor (5000)

W_{(g)}: weight of sample (g)

E_{coeff}: Specific extinction coefficient 1036 at 539 nm

1.7. Results

| No. | Content % | Average % |
|---|---|---|
| 1 | 14.48 | 14.49 |
| 2 | 14.49 | |

Identification of specific anthocyanins in the purified red cabbage extract (HPLC-MS method) and fresh red cabbage

Column: Waters Symmetry RP 8 (250×4.6 mm)

Flow rate: 1 ml/min

Column temperature: 30° C.

Detection: 520 nm

Injection volume: 20 μl

Solvent A: 4.5% formic acid in H₂O

Solvent B: Acetonitrile

| | | | |
|---|---|---|---|
| Gradient: | 5% to 20% B | 0-25 | min |
| | 20% to 25% B | 25.1-40 | min |
| | 25% to 25% B | 40.1-50 | min |

MS settings:

pos. ESI (3500 keV)

Frag. 200-250

N₂-Flow; 13 L/min

Drying gas temperature: 350° C.

Nebulizing pressure: 50 psi

Scan m/z 120-m/z 1500

The results are shown in FIGS. 7 through 20.

### Example 6

### Preparation of Coloring Solution and Coloring Powder

1 g purified red cabbage extract powder prepared in example 1 was dissolved in 100 ml purified water to obtain a solution. 0.1 g AlCl₃ (The amount of Al³⁺ did not influence the color of the solution significantly; not to be limited by theory, but it is possible that a hyperchromic effect may be involved in the resulting blue color) was added into the solution with stirring to obtain a blue colored solution.

The blue colored solution was spray dried to obtain a blue colored powder.

### Example 7

### Color of the Colored Solution Prepared in Example 6 under low pH conditions.

The colored solution prepared in Example 6 was diluted to 0.3 g purified red cabbage extract/L, and the pH of the coloring solution was adjusted to 2.0-4.0 with a pH regulator. The pH regulator, for example, was acetic acid.

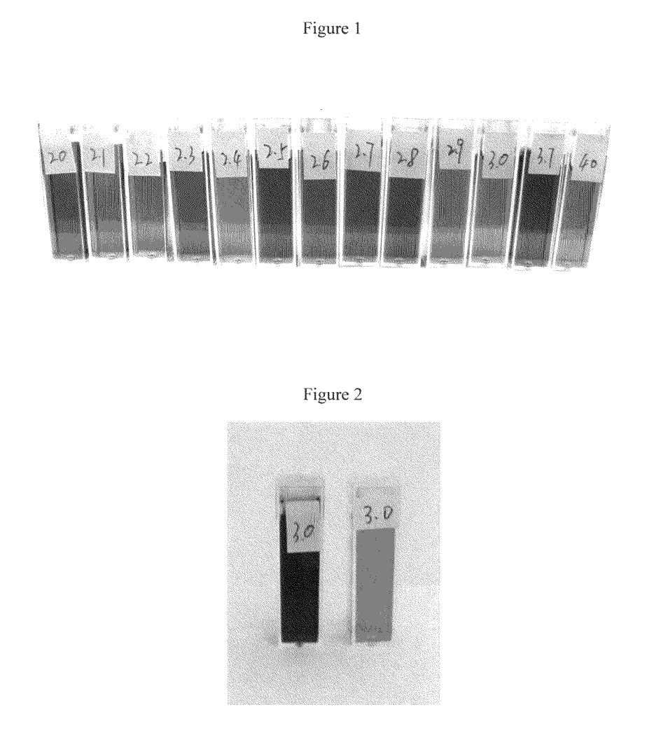

The results showed that the colored solution prepared in Example 6 exhibited a bluish color under low pH conditions. FIG. 1 depicts an excellent blue color over a pH range of 2.3-4.0 was achieved, and a “bluish” color with a red tint was noted over a pH range of 2.0-2.2.

### Example 8

### Comparative Experiments

Control samples were prepared according to the method disclosed in U.S. Pat. No. 7,279,189. 6.0 g red cabbage extract (Wuhan Green Food Biological Engineering Co. Ltd., Lot: WGFC110930(II)) was placed in a container. 0.8 g aluminum sulfate was then added and vigorously mixed with the red cabbage extract in order to dissolve the aluminum sulfate in the red cabbage extract. 0.4 g sodium bicarbonate was then added, in order to obtain the control colorant solution.

The control colorant solution and the solution prepared in Example 6 was diluted to 0.3 g red cabbage extract/L with purified water, respectively, and were tested at pH 3.0, 3.5 and 3.7.

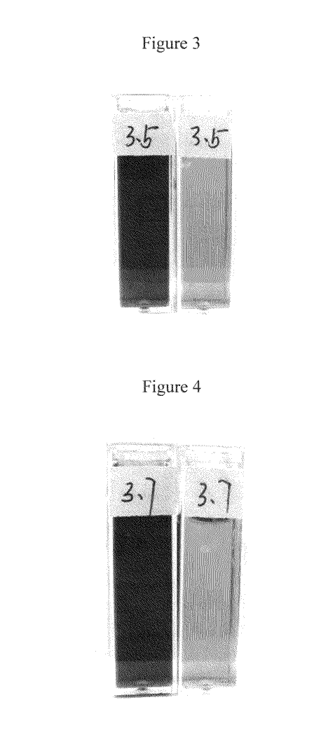

The results showed that the solution prepared in Example 6 exhibit a blue color at pH 3.0, 3.5 and 3.7, whereas the control colorant solution exhibited a red color at the same pH values. See FIGS. 2 through 4 for the comparative results.

U.S. Pat. No. 7,279,189 disclosed a blue solution, which comprises red cabbage liquid (i.e., an extract), aluminum sulfate, and sodium bicarbonate provides a natural blue colorant solution with a pH in the range of 3.7-4.2. Due to the color differences between the presently disclosed materials and that disclosed in the U.S. Pat. No. 7,279,189 patent, it is believed that the red cabbage extract described herein is quite different from the extract used in the U.S. Pat. No. 7,279,189 patent and differentiates the present invention from that described in U.S. Pat. No. 7,279,189. In order to prove the novelty and inventiveness of the present preparations, solutions described in U.S. Pat. No. 7,279,189 were prepared and compared to the color of the materials prepared herein under low pH conditions. It was shown that the present solutions have a blue color while the U.S. Pat. No. 7,279,189 solutions have a red color when compared at equivalent pH ranges.

### Example 9

### Color Compounding

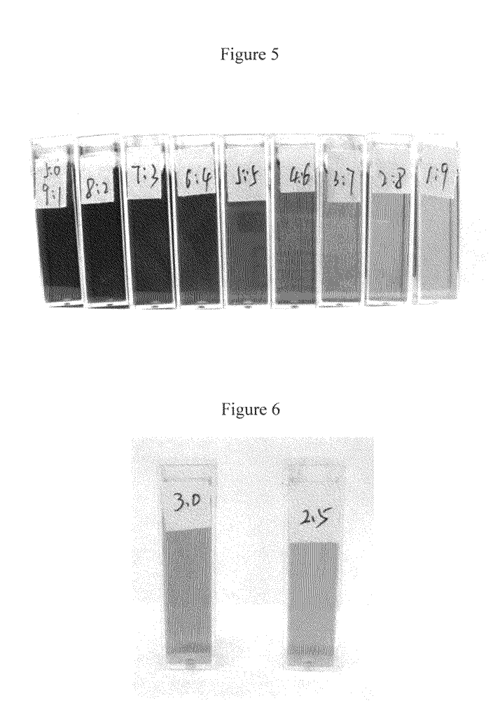

30 mg purified red cabbage extract prepared in Example 5 was dissolved in 100 ml purified water to obtain a solution (0.3 g red cabbage extract/L). 3 mg AlCl₃ was added to the solution (red cabbage extract: AlCl₃=10:1 weight ratio) to provide a blue solution. 30 mg riboflavin (Sinopharm Chemical Reagent Beijing Co. Ltd.) was dissolved in 100 ml purified water to obtain a yellow solution (0.3 g riboflavin/L). The red cabbage extract-AlCl₃ solution was mixed with the riboflavin solution with volume ratios of 9:1, 8:2, 7:3, 6:4, 5:5, 4:6, 3:7, 2:8, 1:9 at pH 5.0. The results showed that a spectrum of green colors can be obtained by properly combining the blue colored solution according to the present invention with a yellow colored substance by conventional methods. See FIG. 5.

30 mg purified red cabbage extract prepared in Example 5 was dissolved in 100 ml purified water to obtain a solution (0.3 g red cabbage extract/L). 3 mg AlCl₃ was added to the solution (red cabbage extract: AlCl₃=10:1 weight ratio). 30 mg riboflavin (Sinopharm Chemical Reagent Beijing Co. Ltd.) was dissolved in 100 ml purified water to obtain a solution (0.3 g riboflavin/L). The red cabbage extract-AlCl₃ solution was mixed with the riboflavin solution with a volume ratio of 5:5 at pH 3.0 and 2.5, respectively. The results showed that green color can be obtained at low pH by properly compounding the blue colored solution according to the present invention with a yellow colored substance by conventional methods. See FIG. 6.

A green colored solution was prepared at low pH by compounding the blue coloring solution with a yellow coloring substance. It is considered that any color that can be formed by compounding the blue color with other color(s). Other colors include, but are not limited to, (acid-stable) green, grape red, pomegranate red, and caramel color.

According to procedures detailed above, pomegranate red color and grape red color were obtained by compounding the blue solution of the present invention with elderberry extract and/or aronia extract, and caramel color was obtained by compounding the blue solution of the present invention with elderberry extract, aronia extract and/or safflower yellow.

The inventions illustratively disclosed herein suitably may be practiced in the absence of any element which is not specifically disclosed herein. Additionally, the inventions illustratively disclosed herein may be practiced in the absence of any element disclosed herein.

Although the present invention has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

What is claimed is:

1. An acylated anthocyanin-enriched red cabbage extract, wherein the extract contains anthocyanin components in increased concentrations than the percentages that occur in non-processed red cabbage.

2. The acylated anthocyanin-enriched red cabbage extract according to claim 1, wherein the acylated anthocyanin is a mono acylated anthocyanin and/or a diacylated anthocyanin.

3. The acylated anthocyanin-enriched red cabbage extract according to claim 1, wherein the acylated anthocyanin extract comprises Cyan-3 (caf)(sin)soph-5-glu, Cyan-3 (sin)triglu-5-glu, Cyan-3(sin)(p-coum)triglu-5-glu, Cyan-3 (sin)(sin)soph-5-glu, Cyan-3 (sin)(fer)triglu-5-glu, Cyan-3(sin)soph-5-glu, Cyan-3(fer)soph-5-glu, Cyan-3(p-coum)glu-5-glu, Cyan-3(sin)(sin)soph-5-glu, Cyan-3(sin)(fer)soph-5-glu, Cyan-3(sin)(p-coum)soph-5-glu, or mixtures thereof.

4. The acylated anthocyanin-enriched red cabbage according to claim 3, wherein Cyan-3(sin)soph-5-glu) and/or (Cyan-3(sin)(sin)soph-5-glu) are present from about 0 to 100 percent by weight.

5. The acylated anthocyanin-enriched red cabbage according to claim 4, wherein one or more of Cyan-3(caf)(sin)soph-5-glu diacyl, Cyan-3(sin)triglu-5-glu monoacyl, Cyan-3(sin)(p-coum)triglu-5-glu diacyl, Cyan-3(sin)(sin)soph-5-glu diacyl, Cyan-3(sin)(fer)triglu-5-glu diacyl, Cyan-3(fer)soph-5-glu monacyl, Cyan-3(p-coum)glu-5-glu monoacyl, Cyan-3(sin)(fer)soph-5-glu diacyl or Cyan-3(sin)(p-coum)soph-5-glu diacyl are present in an amount of from greater than 0 weight percent to about 20 percent by weight based on 100 weight percent.

6. A blue anthocyanin based colorant composition comprising one or more of Cyan-3(caf)(sin)soph-5-glu, Cyan-3(sin)triglu-5-glu, Cyan-3(sin)(p-coum)triglu-5-glu, Cyan-3(sin)(sin)soph-5-glu, Cyan-3(sin)(fer)triglu-5-glu, Cyan-3(sin)soph-5-glu, Cyan-3(fer)soph-5-glu, Cyan-3(p-coum)glu-5-glu, Cyan-3 (sin)(sin)soph-5-glu, Cyan-3 (sin)(fer)soph-5-glu, Cyan-3 (sin)(p-coum)soph-5-glu, or mixtures thereof; and
an aluminum containing compound.

7. The blue anthocyanin based colorant composition of claim 6, wherein the aluminum containing compound is an aluminum halide, aluminum sulfate, and/or a potassium aluminum sulfate.

8. The blue anthocyanin based colorant composition of claim 6, further comprising riboflavin (vitamin B2), safflower yellow, gardenia yellow, citrus yellow, celery yellow, saffron extract or combinations thereof, to provide a green color.

9. The blue anthocyanin based colorant composition of claim 6, further comprising elderberry extract and/or aronia extract, to provide a pomegranate or a grape red color.

10. The blue anthocyanin based colorant composition of claim 6, further comprising elderberry extract and/or aronia extract and safflower yellow, gardenia yellow, citrus yellow, celery yellow, saffron extract or combinations thereof, to provide a caramel color.

11. The blue anthocyanin based colorant composition of claim 6, further comprising a flavonoid.

12. The blue anthocyanin based colorant composition of claim 11, wherein the flavonoid is a celery extract, to provide a green color.

13. The blue anthocyanin based colorant composition of claim 12, wherein the flavonoid is derived from 2-phenylchromen-4-one, 3-phenylchromen-4-one or 4-phenylchromen-4-one.

14. A blue anthocyanin based colorant composition, comprising Cyan-3(sin)soph-5-glu), (Cyan-3(sin)(sin)soph-5-glu) or both; and
an aluminum compound.

15. The blue anthocyanin based colorant composition of claim 14, wherein the aluminum containing compound is an aluminum halide, aluminum sulfate, and/or a potassium aluminum sulfate.

16. The blue anthocyanin based colorant composition of claim 14, further comprising riboflavin (vitamin B2), safflower yellow, gardenia yellow, citrus yellow, celery yellow, saffron extract or combinations thereof, to provide a green color.

17. The blue anthocyanin based colorant composition of claim 14, further comprising elderberry extract and/or aronia extract, to provide a pomegranate or a grape red color.

18. The blue anthocyanin based colorant composition of claim 14, further comprising elderberry extract and/or aronia extract and safflower yellow, gardenia yellow, citrus yellow, celery yellow, saffron extract or combinations thereof, to provide a caramel color.

19. The blue anthocyanin based colorant composition of claim 14, further comprising a flavonoid.

20. The blue anthocyanin based colorant composition of claim 19, wherein the flavonoid is a celery extract comprising 2-phenylchromen-4-one, 3-phenylchromen-4-one or 4-phenylchromen-4-one, to provide a green color.
